(19) United States
(12) Patent Application Publication
(10) Pub. No.: US 2015/0109883 A1
(43) Pub. Date: Apr. 23, 2015

(54) WIRELESS SUBSEA SEISMIC SENSOR AND DATA COLLECTION METHODS

(71) Applicant: Vetco Gray Controls Limited, Bristol (GB)

(72) Inventors: Anthony Jason Vangasse, North Somerset (GB); Raymond Phillips, North Somerset (GB); Dean Arnison, North Somerset (GB)

(21) Appl. No.: 14/397,010

(22) PCT Filed: Apr. 26, 2013
(86) PCT No.: PCT/EP2013/058813

§ 371 Date: Oct. 24, 2014

(30) Foreign Application Priority Data
Apr. 26, 2012 (EP) 12165806.6

(51) Int. Cl. G01V 1/18; G01V 1/22

(52) U.S. Cl. CPC G01V 1/18; G01V 1/22; G01V 1/181; G01V 1/186; G01V 1/38
USPC 367/15

(57) ABSTRACT

A wireless subsea seismic sensor capable of independent location and operation in arrays, and methods of data collection from arrays of such sensors.

### FIELD OF THE INVENTION

Embodiments of the present invention relate to seismic sensors and their method of operation and, in particular, to subsea seismic sensors for subsea deployment in arrays on the sea bed and their operation using wireless communications.

### BACKGROUND TO THE INVENTION

Seismic surveys are carried out to search for and manage reserves of oil and gas in underground rock formations. Such surveys utilize the reflection or refraction of seismic waves by geologic layers and rock/soil in order to characterize the subsurface geological conditions and structures that may contain hydrocarbons. When rock formations to be surveyed are under the sea, arrays of sensors may be typically deployed on the sea surface, for example, by being towed behind a survey vessel. However, a floating array of sensors can only detect longitudinal or pressure waves (p-waves), because transverse, or shear waves (s-waves) produced from a controlled seismic source of energy do not travel through water. More information can be gained, and seismic surveys can be more effective, when seismic sensors are located on the seabed. By locating the seismic sensors, such as geophones and hydrophones, and the seismic energy source on the solid seabed, both pressure and shear waves may be introduced directly into the solid seabed and both s-waves and p-waves may be received at the seismic sensors. More detailed Interpretation of the seismic record can then be undertaken to reveal possible hydrocarbon-bearing formations.

Conventionally, seismic sensors are strung into arrays, with sensors wired at fixed intervals. Accurately placing strings of seismic sensors in an array on the seabed is difficult and time consuming. The seabed is not always level and so corrections have to be made when sensors cannot be evenly spaced. The cabling, carrying power and communications between the sensors, constitutes a large capital cost. Electrical wiring also degrades in a subsea environment.

### SUMMARY OF THE INVENTION

The present invention is directed at providing improved subsea seismic sensors, which may be conveniently deployed individually into an array; which may be individually powered; and which each include a communications module, or transceiver, for wirelessly communicating the seismic data and a location signal from each sensor. Adopting wireless communications and using a local battery or power source for each sensor or group of sensors, removes the need for cables to connect the sensors in a fixed array. This substantially reduces the cost of communication with the seismic sensors by elimination of the costly wiring between the sensors. Furthermore, embodiments of the present invention allow flexibility of location of the seismic sensors, yet still provides for accurate determination of their position.

The relative positions of individual sensors may be conveniently, and accurately, determined after deployment, using the triangulation of wireless location signals between three or more sensors. It is not necessary to fix the sensors in predetermined relationships to each other as with a wired array. Individual sensors may be more quickly and conveniently placed (and replaced) on the seabed without worrying about their precise positions. Ease of replacement of individual sensors without the necessity for precise initial relocation is also helpful in situations where an array is left in place for an extended period, such as for 4D or time-lapse seismic monitoring of reservoirs in production. The sensors may also include a transducer for determining the depth below the sea level at which the sensor is located on the seabed when in use.

The seismic sensors may comprise 3 or 4 component (3C or 4C) sensors comprising 3 orthogonal geophones with a hydrophone, which are powered either by battery, per sensor, or as a group of sensors connected to a local battery, or alternative subsea power source.

In a first aspect, the invention provides a subsea seismic sensor comprising at least one transducer responsive to physical changes following a seismic event; means for recording data from the or each transducer; and a transceiver for wirelessly transmitting the recorded data from the sensor to a remote data collection device in response to a control signal received from an external source.

In an embodiment, the sensor is adapted to communicate selectively and wirelessly with one or more adjacent similar sensors. Conveniently, the sensor is adapted to determine its position relative to one or more adjacent similar sensors, or the position of another similar sensor relative to it, using wireless communication between the sensors. The sensor can be further adapted to receive and accumulate data from one or more other similar sensors with its own data and to retransmit said accumulated data on to another similar sensor or remote data collection device.

Using wireless communications and independently operable sensors also facilitates alternative methods of data collection from arrays of such sensors.

An embodiment of the present invention further provides a method of collecting data from an array of subsea seismic sensors according to an embodiment, using a remote data collection device, the method comprising wirelessly sending a control signal to each one of a selected plurality of the sensors in the array in turn to initiate wireless transmission of the data from each one of said selected plurality of sensors in turn; and receiving at the remote data collection device the transmitted data from each one of said selected plurality of sensors in turn. Additionally, the method may conveniently include the steps of storing all the received data in the remote data collection device, and subsequently communicating the stored data from the remote data collection device for further processing. The remote data collection device may be a mobile unit installed in a remotely operated vehicle (ROV) or in an autonomous underwater vehicle (AUV), which can be deployed to retrieve data from an array (or several arrays) when necessary, thereby saving on costs of installing a fixed data collection device for every array.

Where the subsea seismic sensors are adapted to communicate with each other, an alternative data collection method according to an embodiment comprises the steps of wirelessly sending a polling signal from the remote data collection device; receiving one or more responses from adjacent sensors in the array; selectively designating a one of the responsive sensors as a first sensor in a communication chain of sensors, said one designated responsive sensor then sending a polling signal and receiving responses from one or more previously undesignated sensors, and selectively designating a one of the previously undesignated responsive sensors as the next sensor in the communication chain and the next sensor repeating the polling and selective designation for a subsequent next sensor in the communication chain and the process repeating until the communication chain has a desired number of sensors or until no sensors remain undesignated; sending a data collection signal from the data collection device to the first designated sensor to commence data collection; propagating the data collection signal along the communication chain from the first to the last designated sensor in the chain; and commencing data transmission from the last designated sensor back up the chain of sensors, each next last designated sensor in the chain successively adding its data to the data received from each previous sensor in the chain, the first designated sensor in the chain finally transmitting the accumulated data from itself and all the previous sensors in the chain on to the data collection device.

The methods according to an embodiment may also conveniently include the step of determining the position of said at least one sensor relative to two or more other sensors in the array by triangulation using wireless signal transmission between the sensors; and transmitting the determined positional data to the remote data collection device.

### BRIEF DESCRIPTION OF THE DRAWINGS

FIG. 1 is a block diagram of a seismic sensor according to an embodiment of the present invention;

FIG. 2 illustrates an array of seismic sensors adapted to communicate individually with a mobile data collection device;

FIG. 3 illustrates a similar array of seismic sensors adapted to communicate individually with a fixed remote data collection device comprising a separate seabed transceiver unit, for onward transmission to a mobile data collection device; and

FIG. 4 illustrates a further array of seismic sensors adapted to communicate sensor by sensor to accumulate data from the array for ultimate onward transmission of the accumulated data via a seabed transceiver unit.

### DETAILED DESCRIPTION OF THE INVENTION

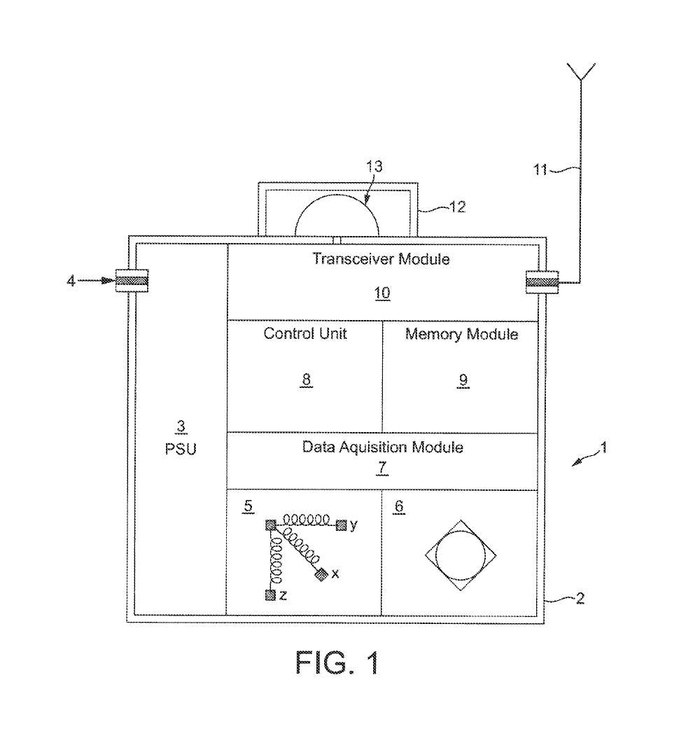

FIG. 1 is a block diagram of a seismic sensor 1 according to an embodiment of the present invention. The sensor 1 comprises a waterproof and pressure-resistant housing 2 enclosing the sensor's electronic modules. A power supply unit (PSU) 3 is provided with rechargeable batteries to supply power to the modules. The PSU may be connected to an external power supply, which can also be used to recharge the internal batteries, via a connector 4. The sensor includes a 3-component geophone 5 to respond to 3-dimensional physical displacement of the sensor and a hydrophone 6 to respond to water pressure variations. In operation, signals from the geophone 5 and hydrophone 6 are passed to the data acquisition module 7. A control unit 8 manages the data acquisition and storage of the data in a memory module 9. The control unit 8 also manages the receipt and transmission of control signals and data to and from external sources via a transceiver module 10 and an antenna 11. The sensor is provided with its own individual electronic identifier (ID) so that signals can be selectively sent to and from each sensor. The sensor 1 is also provided with a handle 12 for mechanical recovery and an automated retrieval mechanism 13 incorporating an electronically operable compressed air cartridge adapted to inflate a balloon to lift the sensor to the sea surface.

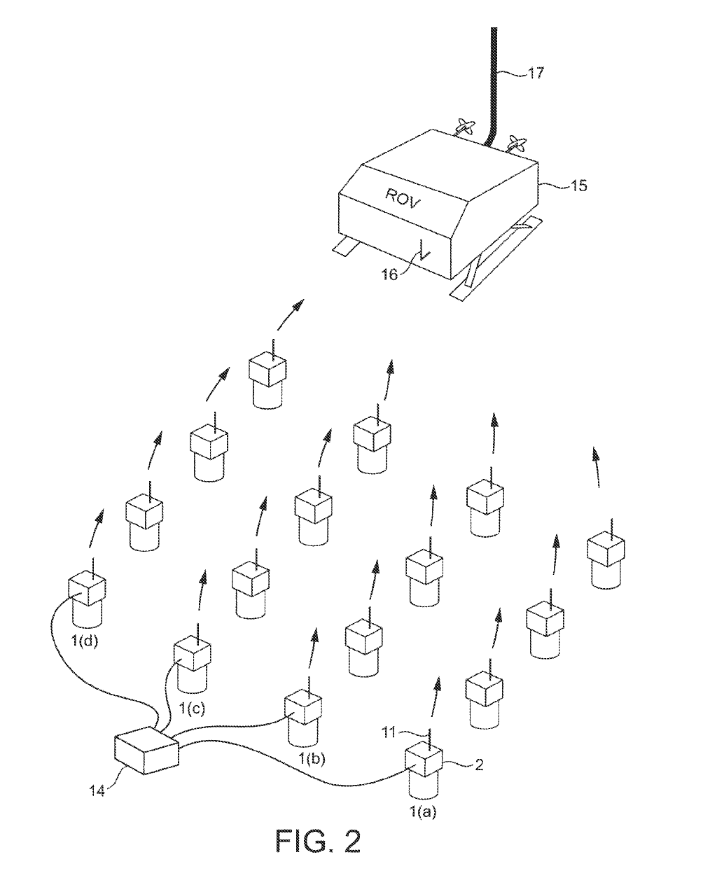

FIG. 2 shows an array of sixteen sensors 1 deployed on the seabed and illustrates a method of data collection, which may be employed using these sensors. Four of the sensors 1(a), (b), (c) and (d) are shown connected to an auxiliary power supply 14. The remaining sensors are all powered individually by their internal PSUs.

In this example, data is collected from the sensors individually by a remotely operated vehicle (ROV) 15, which is controlled, and communicates with the surface, via an umbilical cable 17. The ROV 5 sends control signals via its antenna 16 to interrogate the sensors. In this embodiment, each sensor 1 is individually interrogated and each transmits its data sequentially to the ROV 15. In an alternative embodiment, each sensor may be adjusted to transmit on a slightly different frequency so that the data from different sensors can be collected simultaneously on different frequencies.

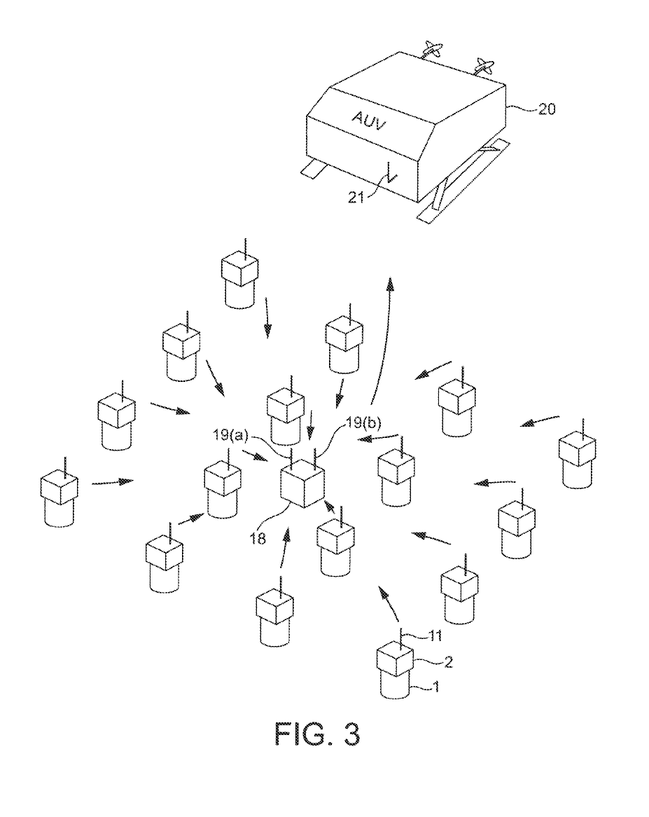

FIG. 3 shows a similar array of sensors 1 set up to use an alternative method of data collection via a local data hub unit 18. In this case, the hub unit 18 is centrally located to collect data from all the sensors 1 in the array. In the illustrated embodiment, data is received from each sensor 1 via its antenna 19(a). The accumulated data is then stored until an autonomous underwater vehicle (AUV) 20 is deployed to collect the data. The AUV 20 is pre-programmed to pass over the array and communicates wirelessly with the hub unit 18, which is instructed to transmit the accumulated data via an antenna 19(b) on the hub unit 18 to an antenna 21 on the AUV 20. As the AUV 20 is not directly connected to the surface via any umbilical connections, the AUV 20 then itself stores the data collected from the hub unit 18 (and can do likewise for multiple arrays and associated other hub units) before returning to the surface when the accumulated data can be downloaded for processing in the normal way.

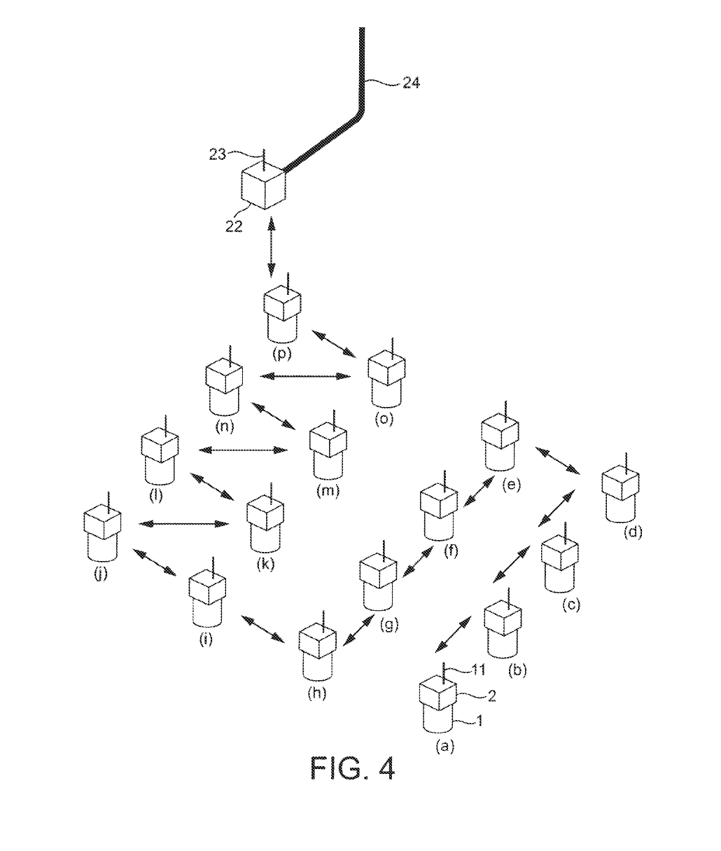

FIG. 4 shows another similar array of sensors 1 set up to use a yet further alternative method of data collection via a subsea base unit 22 which, in this example, is itself connected to, and controlled from, the surface via an umbilical cable 24.

In this embodiment, the base unit 22 is programmed to poll and communicate wirelessly via an antenna 23 with one or more of the sensors in the array. Each sensor 1 is similarly adapted to poll and communicate with one or more adjacent sensors in order to set up a “daisy chain” communication channel using all active sensors in the array (i.e. 1(p) to 1(a) and back).

To set up a suitable channel, the base unit 22 first polls nearby sensors and, on the basis of acquired signal strength, or other appropriate parameter, selects and designates one sensor (typically the nearest—1(p) in the example shown) to start the chain. The first designated sensor then itself polls adjacent sensors and designates a next nearest 1(o). The process continues, with each successively designated sensor further designating the next previously undesignated sensor until all active sensors in the array are designated in turn and the chain is completed. In cases where an array comprises spurs or multiple diverging lines of sensors, then one or more of the sensors may act as an interim node, communicating to and from multiple chains of sensors in order to complete the communication channels to and from the base unit to all the active sensors. Similarly, if a sensor in the chain fails, the adjacent sensors can be programmed to re-route the chain automatically. In this embodiment, when the base unit 22 wishes to initiate data collection from the array, it sends an appropriate trigger command, which is relayed down the chain to the most remote sensor (i.e. to 1(a) in the example). This sensor then responds by transmitting its data to the next sensor 1(b) in the chain, which adds on its data and then transmits the combined data on to the next sensor, and so on until the final sensor 1(p) in the chain transmits the accumulated data for all the active sensors in the array on to the base unit 22.

The use of an interactive, intelligent daisy-chaining of the sensors in the array can overcome problems of communication distance limitations under water, where signals can be subject to rapid attenuation over relatively short distances. This also means sensor transmitters can operate at lower power and for longer periods without needing to recharge batteries, for example.

It will be apparent that various aspects of the methods of data collection illustrated in the examples of FIGS. 2, 3 and 4 may be interchanged or combined in large scale arrays, for example.

In each of the options above, the wireless communication can be through either electromagnetic radio frequency, acoustic or optical means, and the sensors and transmitters may be powered by alternative local sources of electricity such as water current turbines, temperature differential thermocouples, nuclear isotope electrical generators, etc.

Each sensor can be strategically placed relative to other sensors for an effective array. Alternatively, a first sensor or base unit could be placed accurately and the remaining sensors distributed with less accurate initial positioning. Triangulation of signals between sensors (not co-linear) can then be used to locate the sensors relative to each other. The distance to any particular sensor may be determined by measuring the relative time delays in the signal from the sensor to three different sensors close to it. Using individually selectable, wireless seismic sensors according to an embodiment, a decision can be made as to which of the many sensors in an array is to take part in any particular survey, and to define which of the seismic data sources is selected to produce a particular seismic image. Using data from a subset of the total array can effectively allow an analyst to ‘view’ a reservoir from one particular perspective. Similar views can be constructed using different subsets of the total array to get seismic profiles from different angles. These separate ‘views’ may then be combined to improve the resolution of the overall reservoir image.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A subsea seismic sensor, comprising:
at least one transducer responsive to physical changes following a seismic event;
a recorder configured to record data from the at least one transducer; and
a transceiver configured to wirelessly transmit the recorded data from the sensor to a remote data collection device in response to a control signal received from an external source.

2. The sensor according to claim 1, wherein the senor is configured to communicate selectively and wirelessly with one or more adjacent similar sensors.

3. The sensor according to claim 2, wherein the senor is further configured to determine the position of the sensor relative to at least one of the one or more adjacent similar sensors, or the position of at least one of the one or more adjacent similar sensors relative to the sensor, using wireless communication between the sensor and the one or more adjacent similar sensors.

4. The sensor according to claim 2, wherein the senor is further configured to receive and to accumulate data from at least one of the one or more adjacent similar sensors with the data of the sensor and to retransmit the accumulated data on to at least one of the one or more adjacent similar sensors or the remote data collection device.

5. The sensor according to claim 1, wherein the senor is configured to adjust the operating frequency of the transceiver transmissions according to need.

6. The sensor according to claim 1, wherein the at least one transducer comprises a geophone.

7. The sensor according to claim 1, wherein the at least one transducer comprises a hydrophone.

8. The sensor according to claim 1, further comprising a self-contained power supply.

9. The sensor according to claim 8, wherein the self-contained power supply incorporates a rechargeable battery and a recharger configured to recharge the rechargeable battery in situ.

10. The sensor according to claim 1, wherein the transceiver communicates wirelessly using at least one of radio frequency, optical frequency, and acoustic signals.

11. A method of collecting data from an array of subsea seismic sensors, wherein at least one of the subsea seismic sensors comprises at least one transducer responsive to physical changes following a seismic event, a recorder configured to record data from the at least one transducer, and a transceiver configured to wirelessly transmit the recorded data from the at least one sensor to a remote data collection device in response to a control signal received from an external source, using the remote data collection device, the method comprising:
wirelessly sending the control signal to each of a selected plurality of sensors in the array of subsea seismic sensors in turn to initiate wireless transmission of the data from each of the selected plurality of sensors in turn; and
receiving at the remote data collection device the transmitted data from each of the selected plurality of sensors in turn.

12. The method according to claim 11, further comprising:
storing all of the received data in the remote data collection device; and
subsequently communicating the stored data from the remote data collection device for further processing.

13. The method according to claim 11, wherein the remote data collection device is mobilized in an ROV or AUV.

14. A method of collecting data from an array of subsea seismic sensors, wherein at least one of the subsea seismic sensors comprises at least one transducer responsive to physical changes following a seismic event, a recorder configured to record data from the at least one transducer, and a transceiver configured to wirelessly transmit the recorded data from the at least one sensor to a remote data collection device in response to a control signal received from an external source, wherein the at least one senor is configured to communicate selectively and wirelessly with one or more adjacent similar sensors, and to determine the position of the at least one sensor relative to at least one of the one or more adjacent similar sensors, or the position of at least one of the one or more adjacent similar sensors relative to the at least one sensor, using wireless communication between the at least one sensor and the one or more adjacent similar sensors, using the remote data collection device, the method comprising:
wirelessly sending a polling signal from the remote data collection device;
receiving one or more responses from the one or more adjacent similar sensors in the array;
selectively designating one of the responsive sensors as a first sensor in a communication chain of sensors, the first sensor then sending a polling signal and receiving responses from one or more previously undesignated sensors and selectively designating one of the previously undesignated responsive sensors as the next sensor in the communication chain, and the next sensor repeating the polling and selective designation for a subsequent next sensor in the communication chain and the process repeating until the communication chain has a desired number of sensors or until no sensors remain undesignated;
sending a data collection signal from the data collection device to the first designated sensor to commence data collection;
propagating the data collection signal along the communication chain from the first to the last designated sensor in the chain; and
commencing data transmission from the last designated sensor back up the chain of sensors, each next designated sensor in the chain successively adding its data to the data received from each previous sensor in the chain, the first designated sensor in the chain finally transmitting the accumulated data from all the sensors in the chain on to the data collection device.

15. The method according to claim 11, wherein the at least one senor is configured to communicate selectively and wirelessly with one or more adjacent similar sensors, and to determine the position of the at least one sensor relative to at least one of the one or more adjacent similar sensors, or the position of at least one of the one or more adjacent similar sensors relative to the at least one sensor, using wireless communication between the at least one sensor and the one or more adjacent similar sensors, the method further comprising:
determining the position of the at least one sensor relative to two or more adjacent similar sensors in the array by triangulation using wireless signal transmission between the at least one sensor and the two or more adjacent similar sensors; and
transmitting the determined positional data to the remote data collection device.

16. The method according to claim 11, further comprising selectively collecting the data relating to a particular seismic event from a subset of the total number of sensors in the array.
